(19) United States
(12) Patent Application Publication
(10) Pub. No.: US 2017/0373883 A1
(43) Pub. Date: Dec. 28, 2017

(54) PACKET FORWARDING

(71) Applicant: HEWLETT PACKARD ENTERPRISE DEVELOPMENT LP, Houston, TX (US)

(72) Inventor: Weiwei GUO, Beijing (CN)

(21) Appl. No.: 15/539,142

(22) PCT Filed: Dec. 31, 2015
(86) PCT No.: PCT/CN2015/100068

§ 371 Date: Jun. 23, 2017

(30) Foreign Application Priority Data
Dec. 31, 2014 (CN) 201410856181.8

(51) Int. Cl. H04L 12/46; H04W 48/20

(52) U.S. Cl. CPC H04L 12/4633; H04L 12/4641; H04W 48/20

(57) ABSTRACT

The present disclosure provides a method for forwarding a packet. When an access point (AP) receives a first packet from a wireless station, the AP may tunnel encapsulate the first packet and send the first packet through a tunnel to a switch which is designated for the AP by an access controller (AC). When the AP receives a packet from the switch through the tunnel, the AP may tunnel de-capsulate the packet to acquire a second packet, and send the second packet to the wireless station according to a forward table.

### BACKGROUND

In practical network building, a wireless local area network (WLAN) is often deployed in conjunction with a wired network. A wireless station (STA) in a WLAN may forward a packet on a wireless data plane. However, the forwarded packet may be finally delivered to a destination device in a wired network. In a packet forwarding process, a packet may exit a wireless data plane and enter a wired data plane. An edge device, such as an access point (AP) or access controller (AC), may facilitate communication between the wired data plane and the wireless data plane. Hereinafter the edge device may be referred to as a data terminating device.

### BRIEF DESCRIPTION OF THE DRAWINGS

FIG. 1A schematically illustrates a network architecture according to an example of the present disclosure;

FIG. 1B illustrates a flowchart of packet forwarding process according to an example of the present disclosure;

FIG. 2 illustrates a flowchart of a process for establishing a tunnel between an AP and a convergence switch according to examples of the present disclosure;

FIG. 3 illustrates a flowchart of packet forwarding process for transmitting a packet from a wireless STA to a remote server according to an example of the present disclosure;

FIG. 4 illustrates a flowchart of packet forwarding process for transmitting a packet from a remote server to a wireless STA according to an example of the present disclosure;

FIG. 5 illustrates hardware structure of an AP according to an example of the present disclosure; and

FIG. 6 illustrates hardware structure of an AC according to examples of the present disclosure.

### DETAILED DESCRIPTION OF THE EMBODIMENTS

The data terminating device mentioned above may be any physical device on a network responsible for data terminating. For example, the data terminating device may be an access point (AP), and in order to forward a packet transferred from the AP, a switch in a wired network may perform various settings such as configuring a VLAN, which may consume significant processing resources. On the other hand, the data terminating device may be an access controller (AC), in which case the settings of the switch may be reduced. However, in this case, since a great amount of packets to be forwarded may pass through the AC, the forwarding capability of the AC may not be able to satisfy such a demand.

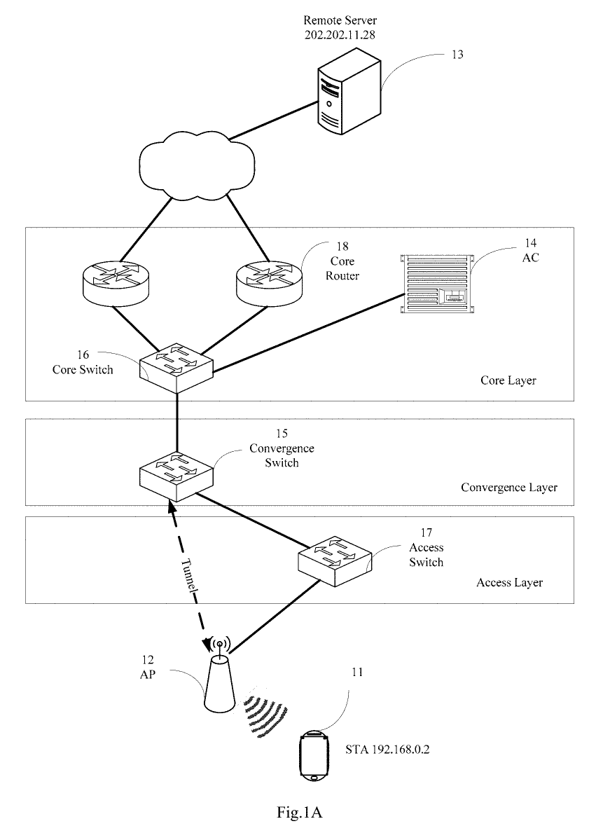

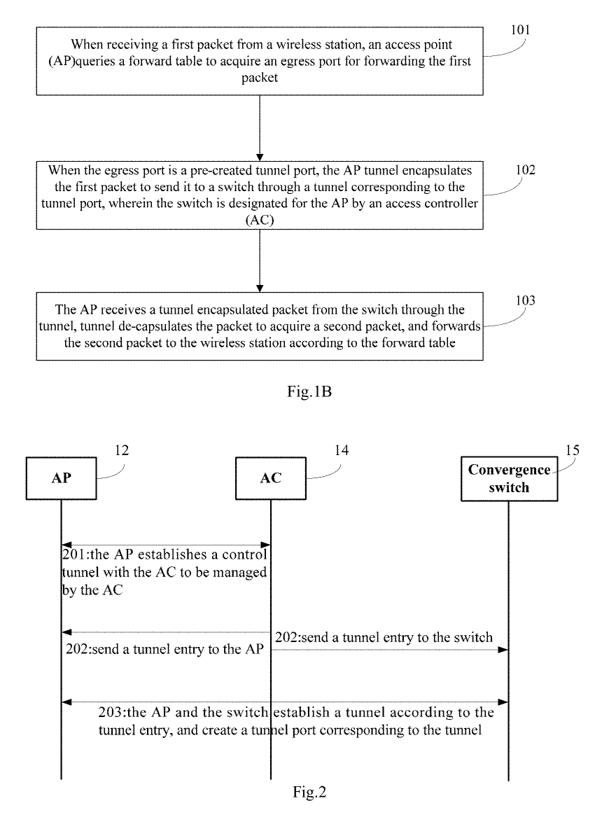

In an example of the present disclosure, a method for forwarding a packet is provided and may be applied in a wireless local area network (WLAN). The method describes how an AP forwards a packet which is sent from a source node such as a wireless station (STA) and directs it to a destination device and receives a packet which is sent from the destination device and directs it to the source node. FIG. 1A illustrates a network architecture to which the method for forwarding a packet may be applied. It should be noted that FIG. 1A is just an example and the method for forwarding a packet is also applicable to other similar network architectures.

The network architecture illustrated in FIG. 1A may include a wireless STA 11, an AP 12 which enables the wireless STA 11 to access a wireless network, an access switch 17, a convergence switch 15, a core switch 16, a core router 18, an access controller AC 14 and a remote server 13. The wireless STA 11 can access the wireless network through the AP 12. The AP 12 may be connected to the AC 14 through a wired network. But for simplicity, one skilled in the art may usually consider the AC 14 as a part of a wireless network. The wireless STA 11 may send a wireless packet to the AP 12, and the AP 12 may perform format conversion on a received wireless packet for forwarding the packet. Then the converted packet can be forwarded to a destination node such as the remote server 13 via switches and other network devices. In one example, suppose that the wireless STA 11 has an IP address of 192.168.0.2, and the remote server 13 may have an IP address of 202.202.11.28. The wired network between the AP 12 and the remote server 13 may include an access layer, a convergence layer and a core layer. The access controller AC 14 on the wireless data plane may be provided on the core layer.

According to an example of the present disclosure, the AP 12 may perform a packet forwarding process for forwarding a first packet received from the wireless STA 11, as shown in FIG. 1B, the packet forwarding process may include blocks 101-103.

At block 101, when receiving a first packet sent from a wireless STA 11, an AP 12 may query a forward table to determine an egress port for forwarding the first packet.

At block 102, when the egress port is a pre-created tunnel port, the AP 12 may tunnel encapsulate the first packet and send it to a switch through a tunnel corresponding to the tunnel port, wherein the switch may be designated for the AP 12 by the AC 14.

At block 103, when receiving a tunnel-encapsulated packet from the switch through the tunnel, the AP 12 may tunnel de-capsulate the packet to acquire a second packet, and forward the second packet to the wireless STA according to the forward table.

When the AP 12 is powered up, it may usually establish a tunnel with the AC 14 so that the AP 12 can be managed by the AC 14. For example, a Control and Provisioning of Wireless Access Points (CAPWAP) tunnel may be established. When the tunnel is established, the AC 14 may designate a switch for the AP 12, and the designated switch may serve as a data terminating device for the AP 12. The designated switch may be a switch device which is separate from the AC. The designated switch may be a switch 15 in the convergence layer, a switch 16 in the core layer or a switch 17 in the access layer. Under control of the AC 14, the AP 12 may establish a tunnel with the designated switch, for example switch 15. The tunnel between the AP 12 and the designated switch may be used to transparently transmit a packet between the wireless STA 11 and the remote server 13. This will simplify the network configuring between the AP 12 and the designated switch. For example, for configuring with respect to the designated switch, VLAN configuring may be omitted for the wireless STA 11.

In the following examples, the switch designated for the AP 12 by the AC 14 may be the convergence switch 15 in the convergence layer, but in other examples the designated switch may be a switch in a different layer. The designated switch, which in this example is the convergence switch 15, may function as a data terminating device to perform data terminating process in the wireless data plane such that a packet may smoothly enter the wired data plane. In addition, another switch such as the core switch 16 may function as a user gateway. In this way, after completing the data terminating, the convergence switch 15 may forward a packet to the core switch 16, and the core switch 16 may perform layer-3 forwarding so as to forward the packet to the remote server 13.

FIG. 2 is an example of a process for establishing a tunnel between an AP 12 and a designated switch, which may for example be the convergence switch 15 or another switch, and illustrates how an AC 14 controls the AP 12 to establish a tunnel with the designated switch. It gives a VXLAN tunnel as an example, but any other kind of tunnel such as Generic Routing Encapsulation (GRE) may also be used.

At block 201, the AP 12 may establish a control tunnel with the AC 14 so as to be controlled by the AC 14.

Wherein, when powered up, the AP 12 may find the AC 14 in a common way such as broadcasting and accordingly establish a control tunnel such as a CAPWAP tunnel with the AC 14.

At block 202, the AC 14 may designate a switch for the AP 12, and send a tunnel entry to the AP 12 and the designated switch respectively. As mentioned above, in one example the designated switch may be the convergence switch 15, but the method is not limited thereto.

Through the CAPWAP tunnel, the AP and the wireless STA can be collectively managed and authenticated by the AC 14. When a wireless STA logging and being authenticated, the AC may identify a VLAN to which the wireless STA belongs. For example, the AC may determine that a wireless STA belongs to a VLAN 100. The AC may control the tunnel establishment between the AP and its corresponding switch according to the relationship between VLANs and wireless STAs. For each of the VLANs, the AP and its corresponding switch can be controlled to establish a corresponding VXLAN tunnel. If the VLAN is not deployed at advance, the correspondence between the VLAN and the VXLAN tunnel may not be considered.

The AC 14 distributes a tunnel entry to the AP 12 and its corresponding switch. The tunnel entry may include an IP address of opposite side and an identifier of established tunnel (hereinafter, it may be referred to as tunnel identifier). For example, the AC 14 may distribute a tunnel entry including the IP address of the convergence switch 15 and a tunnel identifier to the AP 12, and a tunnel entry including the IP address of the AP 12 and the tunnel identifier to the convergence switch 15. According to an example, the AC may further distribute correspondence between a VLAN and a tunnel entry to the AP 12 and the convergence switch 15. The tunnel identifier may be a VXLAN ID converted from corresponding VLAN ID (such as VLAN 100). Since the VLAN ID has a length of 12 bit and the VXLAN ID has a length of 24 bit, each of the VLANs can correspond to a unique VXLAN. For example, the AC may distribute the correspondence between the tunnel entry with a VLAN to the AP 12 through a CAPWAP tunnel, and to the convergence switch 15 through a standard SNMP protocol.

At block 203, the AP 12 may establish a tunnel with the convergence switch 15 according to the tunnel entry and configure a tunnel port corresponding to the tunnel.

According to an example, the AP 12 or the convergence switch 15 may establish a VXLAN tunnel with each other according to the tunnel entry distributed from the AC 14, and thus a packet can be forwarded between the AP 12 and the convergence switch 15 through the VXLAN tunnel. No matter on the AP or the convergence switch, the VXLAN tunnel port may be configured as a virtual layer-2 port. For example, a virtual layer-2 port corresponding to the VXLAN tunnel may be created and added into a forward table on the AP or the convergence switch. Thus, if the AC distributes the correspondence between the VLAN and the tunnel entry, the AP or the convergence switch may join into the VLAN with the tunnel port.

The AC can instruct the AP and the convergence switch to establish a VXLAN tunnel or to terminate the tunnel. For example, when the AC determines that all wireless STAs in a VLAN are disconnected with the AP, the AC may distribute a notification for terminating a tunnel to the AP and the convergence switch, and then, in response to the notification, the AP and the convergence switch may terminate the VXLAN tunnel corresponding to the VLAN. On the other hand, when a VXLAN tunnel is established between the AP and a switch, the AP and the switch may forward packets therebetween through the tunnel, and the process on the AP may be as shown in block 101 to block 103 in FIG. 1B.

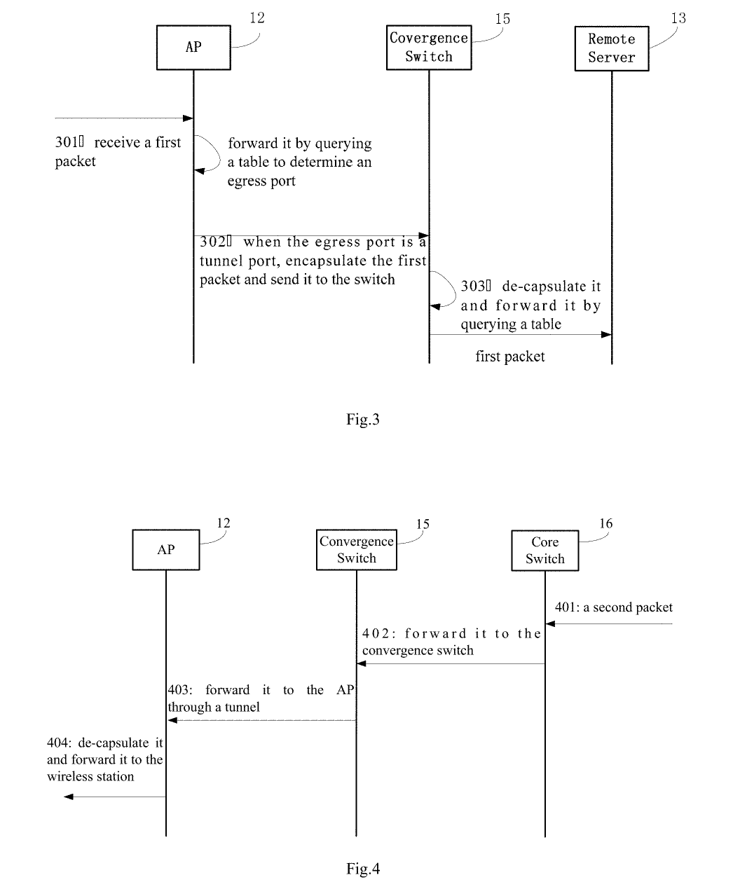

FIG. 3 is an example of a packet forwarding process for transmitting a packet from the wireless STA 11 to the remote server 13.

At block 301, when receiving a first packet from a wireless STA, an AP may query a forward table to determine an egress port for forwarding the first packet.

Wherein, the packet received from the wireless STA may be a unicast packet, a multicast packet or a broadcast packet. When a packet is to be transmitted to a remote server from a wireless STA, since the wireless STA and the remote server may usually be not on the same network segment, the destination MAC (DMAC) address of the packet may be the MAC address of a gateway for the wireless STA, such as the MAC address of the core switch 16. The packet may usually be encapsulated according to the 802.11 protocol and sent to the AP. The AP may receive the packet of the wireless STA from a BSS port (802.11 radio frequency virtualized port), and query a forward table to determine an egress port for forwarding the packet. If the egress port corresponds to a wired network, the packet may be converted into a format according to the 802.3 protocol and then the converted packet may be sent out from the egress port.

At block 302, when the egress port is a pre-created tunnel port, the AP may tunnel encapsulate the first packet and forward it to a switch through a tunnel corresponding to the tunnel port, wherein the switch is designated for the AP 12 by an AC 14, such as a convergence switch 15.

As described in block 301, when receiving a packet from the wireless STA, the AP may query a forward table to determine the egress port. For example, the AP may query the forward table according to the destination MAC address and the VLAN indicated by the packet. If the query result may show that a tunnel entry corresponding to the destination MAC address and the VLAN appears in the forward table, the egress port in the tunnel entry is determined as the tunnel port. Or else, the query result may show the failure of the query, for example, the MAC address of the gateway (such as the core switch) for the wireless STA is not included in the forward table for the AP 12. In this case, the AP may process the packet as unknown unicast packet. Similar to the forwarding of broadcast packet, the AP 12 may determine all ports corresponding to the VLAN indicated by the packet. In an example, in order to reduce the effect which the broadcasting process brings to the VLAN configuring for the access switch, the broadcasting process may exclude a physical port through which the AP may be connected to a wired network from options of the egress port. Supposing that the AP may determine a VLAN 100 according to the first packet and a VLAN 100 may be also deployed on the access switch in advance, both the VLANs 100 may conflict to each other because the AP and the access switch may belong to different network providers.

Besides, if the AP receives a first packet for the first time, the AP 12 may further perform MAC address determining, so as to create correspondence between the determined source MAC address and the BSS port which receives the packet. Similarly, other multicast or unicast packet may be processed using layer-2 forwarding by querying a table to find an egress port for forwarding the packet.

With reference to FIG. 1A, the AP may VXLAN tunnel-encapsulate a first packet received from the wireless STA and send the packet to the convergence switch through the VXLAN tunnel. Since a first packet is encapsulated into a VXLAN packet, the first packet, as the payload data of the VXLAN packet, may not be modified when forwarded before reaches the convergence switch 15. And the devices on the forwarding path may perform packet forwarding according to the header of the VXLAN packet, so the whole forwarding process is transparent.

At block 303, the convergence switch 15 may de-capsulate the VXLAN packet to acquire the first packet, and forward the acquired packet by querying a table.

When receiving a VXLAN packet from the AP 12 through the VXLAN tunnel, the convergence switch 15 may de-capsulate the packet to acquire the first packet. Subsequently, the convergence switch 15 may query a layer-2 forward table according to the DMAC address and the VLAN indicated by the acquired packet. If the query succeeds, the convergence switch 15 may send the packet to a physical port corresponding to the DMAC address; if the query fails, the convergence switch 15 may send the packet to all physical ports corresponding to the VLAN through broadcasting. Further, the switch may usually perform source MAC address determining of the packet, so as to create correspondence between the determined source MAC address and the tunnel port which receives the packet.

After the convergence switch 15 forwards the first packet to the core switch 16 as a gateway, the core switch 16 may start to perform layer-3 forwarding. According to an entry in a layer-3 forward table, the core switch 16 may substitute the DMAC address of the first packet with the next hop MAC address of the remote server, substitute the source MAC (SMAC) address with the MAC address of the core switch 16 itself, and then send these information to next hop device of the remote server, and then forward the packet to the remote server according to ordinary routing forwarding rules.

The above example illustrates a process of forwarding packets from a wireless STA to a remote server. In this process, the AP may perform layer-2 forwarding and establish a tunnel between the AP and a switch to load a great amount of packets, which can reduce the work load of the AC as a data terminating device. For example, a VLAN may correspond to a tunnel such that processing of the great amount of packets may be shared by a plurality of switches. Besides, a tunnel may be a common-used tunnel as long as supported by a switch, therefore may be easily established and applied widely.

When receiving the first packet from the wireless STA 11, the remote server 13 may respond with a second packet. FIG. 4 is an example of the packet forwarding process for sending a second packet from the remote server 13 to the wireless STA 11.

At block 401, the remote server sends a second packet to the core switch 16.

Wherein, the DMAC address of the second packet is the address of the gateway such as the core switch 16, and the destination IP of the second packet is the IP of the wireless STA 192.168.0.2.

At block 402, the core switch 16 forwards the second packet to the convergence switch 15.

Wherein, the core switch 16 performs layer-3 forwarding of the second packet. According to an entry in a layer-3 forward table, the core switch 16 substitutes the DMAC address of the second packet with the MAC address of the wireless STA, substitutes the SMAC address of the packet with the MAC address of the core switch 16, then sends the second packet to the convergence switch 15.

At block 403, the convergence switch 15 forwards the second packet by querying a layer-2 table, and sends the second packet to the AP 12 through a VXLAN tunnel since the egress port is a tunnel port.

Wherein, when receiving the second packet from the core switch 16, the convergence switch 15 performs layer-2 forwarding by querying a layer-2 table according to the VLAN and the DMAC address indicated by the second packet. The convergence switch 15 finds that the egress port corresponding to the DMAC address is a virtualized layer-2 port of VXLAN tunnel, so the converge switch 15 VXLAN tunnel-encapsulates the packet and forward it. The forwarding process of a unicast, multicast or broadcast packet by the convergence switch 15 is similar and thus not repeated. It should be noted that, when the packet is a broadcast packet, the convergence switch may broadcast the packet by traversing all ports in the VLAN. Further, the convergence switch may also perform source MAC address determining so as to create correspondence between the determined source MAC address with the core switch and corresponding port thereof. Thus the above broadcasting may be omitted the next time for a packet being forwarded to the core switch.

At block 404, the AP 12 tunnel de-capsulates the tunnel-encapsulated second datagram to acquire the original second datagram, and forwards the acquired datagram to the wireless station 11 according to the forward table.

In block 404, the AP 12 may terminate the tunnel, de-capsulate the second packet, query a table according to the destination MAC address indicated by the second packet, and determine the egress port to be the BSS port for which the correspondence may have been created with the source MAC address. And therefore, the AP 12 may convert the second packet into a format according to 802.11 and forward the converted packet from the BSS port to the wireless STA. Furthermore, the AP 12 may also perform source MAC address determining of the core switch 16 to establish correspondence between the determined source MAC address and the virtualized layer-2 port of the VXLAN tunnel, such that the above broadcasting may be omitted the next time for a packet being forwarded to the core switch.

Further, when receiving a broadcast packet from the switch through a VXLAN tunnel, the AP broadcasts the packet within the VLAN. And the broadcasting process may exclude a physical port through which the AP may be connected to a wired network from options of the egress port. And generally, the source port of the packet may also be excluded from options of the egress port.

Further, when a switch designated for an AP may be in failure, in order to eliminate inconvenience for use of the AP, the examples of the present disclosure further provide a data backup scheme. For example, an AP may simultaneously establish VXLAN tunnels with a plurality of switches and form a forwarding architecture on multiple data planes so as to backup data. Thus the normal web use may be guaranteed even when a switch does not work.

For example, when an AP may be connected to an AC, the AC may distribute a plurality of tunnel entries to the AP to enable the AP to establish a tunnel with each of a plurality of switches respectively. For example, three switches are designated in the VLAN 100 deployed on the AP, and therefore, a packet from a wireless STA in the VLAN 100 may be transmitted through three available tunnels. In this way, on the AP side, there may be multiple VXLAN virtual tunnel ports in the VLAN, which correspond to a plurality of tunnels established between the AP and the switches. In order to avoid formation of a loop, both the AP and the switch may use the spanning tree protocol (STP) function. And wherein, multiple tunnel ports on the AP may participate in the operation of the STP spanning tree, but only a tunnel port selected may participate in forwarding of a packet, and other tunnel ports may be in a backup state and be used when the tunnel port selected is in failure. For example, when the tunnel port selected by the STP fails, another tunnel port may be automatically switched into a FORWARD state from the backup state to participate in the forwarding. The entire process may be controlled according to the STP, as long as a tunnel port may support a few of port states (such as LEARNING; DISCARDING; and FORWARDING) regulated by the STP and may upload a BPDU (Bridge Protocol Data Unit) packet as a message frame exchanged between switches running the STP to a STP control module of a network device.

In another example, considering that a switch may have strong process abilities, an AC may be implemented by an on board processor of a switch executing corresponding software. Therefore, a switch may be logically provided with functions of an AC. This type of AC may be usually applicable to small business network. For example, an ordinary switch may be upgraded through software into a switch supporting AC functions, so as to integrate wired and wireless services. This is equivalent to a control function of an AC being provided on a processor of a switch. Therefore, an AP may find an AC (the switch) in an ordinary way, establish a CAPWAP control tunnel with the AC, and be managed by the AC. Then the AC may establish a VXLAN tunnel with the AP and introduce data into the switch, and the packet forwarding process is similar to that in the above-described examples. In this way, an ordinary switch may be upgraded into an AC, so additional cost for purchasing an AC can be saved and the forwarding capacity of a switch can be fully utilized. Here, it should be noted that although a switch may function as an AC simultaneously, a tunnel for forwarding a packet may be separate from a control tunnel, thus the processing pressure for a data terminating device such as a switch or an AC can be reduced as still. And since an AP may be designated with other switches, the processing pressure for the data terminating device can be further reduced. Further, the above method can also unify wired or wireless data policies, for example, policies such as QoS and access control may also be applied in wireless environment.

FIG. 5 illustrates hardware structure of an AP 12 including a processor 510, a communication interface 520, a memory 530, a non-transitory storage medium 540 and a bus 550. The processor 510, the communication interface 520, the memory 530 and the non-transitory storage medium 540 may communicate with each other through the bus 550. In an example, the non-transitory storage medium 540 may store logic for packet forwarding including a series of machine readable instructions which may be read into the memory and executed by the processor 510. When the machine readable instructions are executed, the above described process for the AP 12 may be achieved.

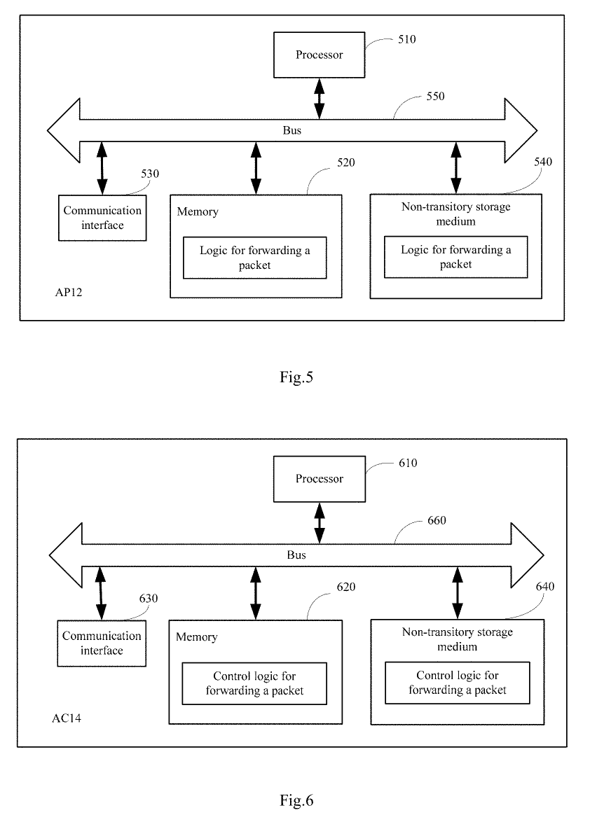

FIG. 6 illustrates hardware structure of an AC 14 including a processor 610, a communication interface 620, a memory 630, a non-transitory storage medium 640 and a bus 650. The processor 610, the communication interface 620, the memory 630 and the non-transitory storage medium 640 may communicate with each other through the bus 650. In an example, the non-transitory storage medium 640 may store control logic for packet forwarding including a series of machine readable instructions which may be read into the memory and executed by the processor 610. When the machine readable instructions are executed, the above-described processing for the AC 14 may be achieved.

The above examples are merely illustrative but not intended to limit the disclosure, and any modifications, equivalent substitutions, adaptations thereof made without departing from the spirit and scope of the disclosure shall be encompassed in the claimed scope of the appended claims.

1. A method for forwarding a packet, includes:
querying, by an access point (AP), a forward table to determine an egress port for forwarding a first packet received from a wireless station (STA);
tunnel encapsulating, by the AP, the first packet when the egress port is a pre-created tunnel port,
sending, by the AP, the tunnel encapsulated first packet to a switch through a tunnel corresponding to the tunnel port, wherein the switch is designated for the AP by an access controller (AC); and
tunnel de-capsulating, by the AP, a tunnel-encapsulated packet received from the switch through the tunnel to acquire a second packet, and
sending, by the AP, the second packet to the wireless STA according to the forward table.

2. The method according to claim 1, further includes:
establishing, by the AP, a control tunnel with the AC so as to make the AP be controlled by the AC, wherein the control tunnel is a tunnel different from the tunnel between the AP and the switch.

3. The method according to claim 2, wherein,
the control tunnel is a Control and Provisioning of Wireless Access Points (CAPWAP) tunnel, and
the tunnel between the AP and the switch is a Virtual Extensible Local Area Network (VXLAN) tunnel.

4. The method according to claim 1, wherein, in a case that the first packet is a broadcast packet, the method further includes:
excluding, by the AP, a physical port through which the AP is connected to a wired network from options of the egress port.

5. The method according to claim 1, wherein, before the first packet is received, the method further includes:
receiving, by the AP, a correspondence between a virtual local area network (VLAN) to which the wireless STA belongs and a tunnel entry, wherein, the correspondence is transmitted from the AC,
creating a tunnel port, by the AP, according to the tunnel entry, and
adding the tunnel port, by the AP, to the VLAN.

6. The method according to claim 5, wherein, in a case that the tunnel entry includes IP addresses and tunnel identifiers of a plurality of switches, the method further includes:
creating, by the AP, a plurality of tunnel ports according to the tunnel entry,
adding, by the AP, each of the tunnel ports into the VLAN;
selecting, by the AP, one of the tunnel ports as a main tunnel port for forwarding a packet according to a spanning tree protocol (STP), and
configuring, by the AP, others of the tunnel ports as backup tunnel ports.

7. A method for controlling packet forwarding, includes:
establishing, by an access controller (AC), a control tunnel with an access point (AP) to manage the AP;
designating, by the AC, a switch to the AP; and
instructing, by the AC, the AP and the switch to establish a tunnel between the AP and the switch.

8. The method according to claim 7, wherein, said instructing the AP and the switch to establish the tunnel includes:
sending, by the AC, a tunnel entry to the AP and the switch respectively, wherein,
the tunnel entry sent to the AP includes a tunnel identifier and an IP address of the switch, and
the tunnel entry sent to the switch includes the tunnel identifier and an IP address of the AP.

9. The method according to claim 8, wherein,
the control tunnel between the AP and the AC is a CAPWAP tunnel, and
the tunnel between the AP and the switch is a VXLAN tunnel.

10. The method according to claim 9, further includes:
sending, by the AC, a correspondence between a VLAN and a tunnel entry to the AP and the switch, wherein the VLAN includes a wireless station (STA) which accesses a wireless network through the AP, so as to instruct the AP and the switch to add a tunnel port into the VLAN.

11. The method according to claim 10, further includes:
distributing, by the AC, a plurality of tunnel entries to the AP, so as to enable the AP to establish tunnels with at least one switch according to the tunnel entries.

12. An access point (AP), including a processor and a storage medium, wherein the storage medium stores machine readable instructions which are executable by the processor to:
query a forward table to determine an egress port for forwarding a first packet received from a wireless station (STA);
tunnel encapsulate the first packet when the egress port is a pre-created tunnel port,
send the tunnel encapsulated first packet to a switch through a tunnel corresponding to the tunnel port, wherein the switch is designated for the AP by an access controller (AC);
tunnel de-capsulate a tunnel-encapsulated packet received from the switch through the tunnel to acquire a second packet, and
send the second packet to the wireless STA according to the forward table.

13. The AP according to claim 12, wherein, the instructions are executed to further cause the processor to:
establish a control tunnel with the AC so as to be controlled by the AC, wherein
the control tunnel between the AP and the AC is a CAPWAP tunnel, and
the tunnel between the AP and the switch is a VXLAN tunnel.

14. The AP according to claim 12, wherein, in a case that the first packet is a broadcast packet, the instructions are executed to further cause the processor to:
exclude a physical port through which the AP is connected to a wired network from options of the egress port.

15. The AP according to claim 12, wherein, the instructions are executed to further cause the processor to:
receive a correspondence between a VLAN to which the wireless STA belongs and a tunnel entry, wherein the correspondence is transmitted from the AC,
create a tunnel port according to the tunnel entry, and
add the tunnel port into the VLAN.
